(19) United States
(12) Patent Application Publication
(10) Pub. No.: US 2024/0151002 A1
(43) Pub. Date: May 9, 2024

(54) AN ENERGY EFFICIENT HYDRAULIC SYSTEM FOR CONSTRUCTION MACHINES

(71) Applicant: HUSQVARNA AB, Huskvarna (SE)

(72) Inventors: Masoud Varshosaz, Sävedalen (SE); Tommy Olsson, Lerum (SE)

(21) Appl. No.: 18/280,075

(22) PCT Filed: Feb. 28, 2022
(86) PCT No.: PCT/SE2022/050202

§ 371 Date: Sep. 1, 2023

(30) Foreign Application Priority Data
Mar. 4, 2021 (SE) 2150253-9

(51) Int. Cl. E02F 9/22; F15B 13/04

(52) U.S. Cl. CPC E02F 9/2203; E02F 9/2267; F15B 13/0401

(57) ABSTRACT

A hydraulic system (400) for a construction machine, the system comprising a hydraulic pump (410), a hydraulic tank (420), one or more actuator control valves (430, 440) arranged to control respective actuators on the construction machine, and a control unit (300) arranged to configure respective valve positions of the actuator control valves and to control a hydraulic flow generated by the pump (410), wherein at least one of the actuator control valves (430, 440) is a pressure compensated flow control valve, and where, in a first mode of operation, the control unit (300) is arranged to control the hydraulic pump (410) to deliver a hydraulic flow at a pre-determined flow level at or below a total flow requirement of the actuators.

### TECHNICAL FIELD

The present disclosure relates to construction machines such as remotely controlled demolition robots, excavators, and the like. There are disclosed energy efficiency hydraulic systems, control units, methods and construction machines associated with an increased energy efficiency.

### BACKGROUND

Construction machines such as light demolition robots have traditionally been powered by combustion engines or from electrical mains via cable.

Recently, hybrid electric demolition robots have been proposed, e.g., in EP2842213 A1. This machine comprises an auxiliary energy source, such as a battery, which allows for a temporary power outtake above the capability of the main power source. Thus, if the electrical mains is rated at, say 10 A, the combination of battery and electrical mains may together supply higher currents for a limited duration of time.

Energy efficiency is of course of importance in all types of construction equipment, but it is of particular relevance for light-weight demolition robots which may be required to operate in environments lacking a high-power energy source.

The energy efficiency of a construction machine is also important for other reasons, such as for reducing environmental impact and carbon footprint by the machine.

There is a need to improve the energy efficiency in the above-mentioned types of construction machines.

### SUMMARY

It is an object of the present disclosure to provide more energy efficient hydraulic systems. This object is at least in part obtained by a hydraulic system for a construction machine. The system comprises a hydraulic pump, a hydraulic tank, one or more actuator control valves arranged to control respective actuators on the construction machine, and a control unit arranged to configure respective valve positions of the actuator control valves and to control a hydraulic flow generated by the pump, where at least one of the actuator control valves is a pressure compensated flow control valve. In a first mode of operation, the control unit is arranged to determine a total flow requirement of the actuators and to control the hydraulic pump to deliver a hydraulic flow at or below the total flow requirement of the actuators by a predetermined amount.

The proposed system, in its above mode of operation, does not generate an operating pressure which is above the load pressure by a margin. Instead, just enough or a little bit less flow than required by the actuators is generated. This results in an improved energy efficiency of the hydraulic system, normally on the order of about 10% or more depending on the load pressure. Moreover, with this configuration there is no need for a pressure transducer.

According to aspects, the total flow requirement of the actuators is determined at least in part based on the configured hydraulic valve positions. This way the control unit is able to establish the required flow to be generated in an efficient and reliable manner. The implementation may, e.g., be based on a look-up-table or the like which can be implemented at limited computational complexity.

According to aspects, each valve comprises a sensor arrangement configured to sense a differential pressure over the valve and the total flow requirement of the actuators is determined at least in part based on the differential pressures over the valves. This way an alternative method for determining flow requirement is provided. This method can be used independently of the above method, or in combination, resulting in an even more robust system. Of course, a spring-loaded pressure compensator can also be used, which is normally a lower cost option.

According to aspects, the hydraulic system comprises a load sensing valve comprised in a load sensing system, where the total flow requirement of the actuators is determined based on a state of the load sensing valve. This represents a simple mechanism for determining required flow which can be implemented with a minimum of computation requirement.

According to aspects, the hydraulic system also comprises a non flow-compensated valve arranged to control a high-power actuator. It is an advantage that the proposed technique also allows for non flow-compensated valves since such valves are suitable for actuators with high power requirements.

According to aspects, the hydraulic system is also able to operate in a second mode of operation. In this mode of operation the control unit is arranged to control the hydraulic pump to deliver a hydraulic flow at a flow level above the total flow requirement of the actuators and the control unit is arranged to configure the hydraulic system to operate in one of the first mode of operation and the second mode of operation. This second mode of operation is akin to a boost mode and is associated with an increased hydraulic system performance compared to the more energy efficient first mode of operation described above. The second mode of operation may be activated temporarily when the need for increased performance arises. Optionally, when the hydraulic system is configured in the second mode of operation, the control unit is arranged to control the hydraulic pump to deliver a hydraulic pressure above a load pressure in the hydraulic system by a configurable or a fixed margin. The control unit may be arranged to select the first or the second mode of operation in dependence of which actuators that are controlled and/or in dependence of an input by an operator.

According to aspects, the hydraulic system comprises a load sensing system with at least one load sensing valve, the hydraulic pump is a variable speed drive fixed displacement pump, and the control unit is configured to maintain a variable speed drive setting above a predetermined speed value. This ensures that the pump arrangement always operates above the minimum speed value. This is an important feature in some systems which require a minimum drive speed at all times in order to ensure that the arrangement is properly lubricated and perhaps also that cooling works as intended. The predetermined speed value is optionally configured in dependence of any of; a hydraulic system pressure, an operation time duration, and/or an operating temperature, which are all system parameters that determine a need for a given speed value.

There are also disclosed herein construction machines, actuator control units, controllers, processing circuits, computer programs, computer program products as well as methods associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example demolition robot;

FIG. 2 shows an example remote control device;

FIG. 3 schematically illustrates a hydraulics system control unit;

FIG. 4 shows an example hydraulics system;

FIG. 5 is a flow chart; and

FIG. 6 schematically illustrates a control unit.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

The present disclosure relates to controlling one or more actuators on a construction machine, such as a percussion hammer or breaker, boom and stick motion of a tool carrier arm, body swing, and/or caterpillar tracks or drive wheel motion. It is appreciated that the control arrangements and methods disclosed herein can be used with advantage in demolition robots, and in particular in electrically powered remote-controlled demolition robots. However, many of the techniques discussed herein are also applicable in other types of construction machines, such as excavators and the like.

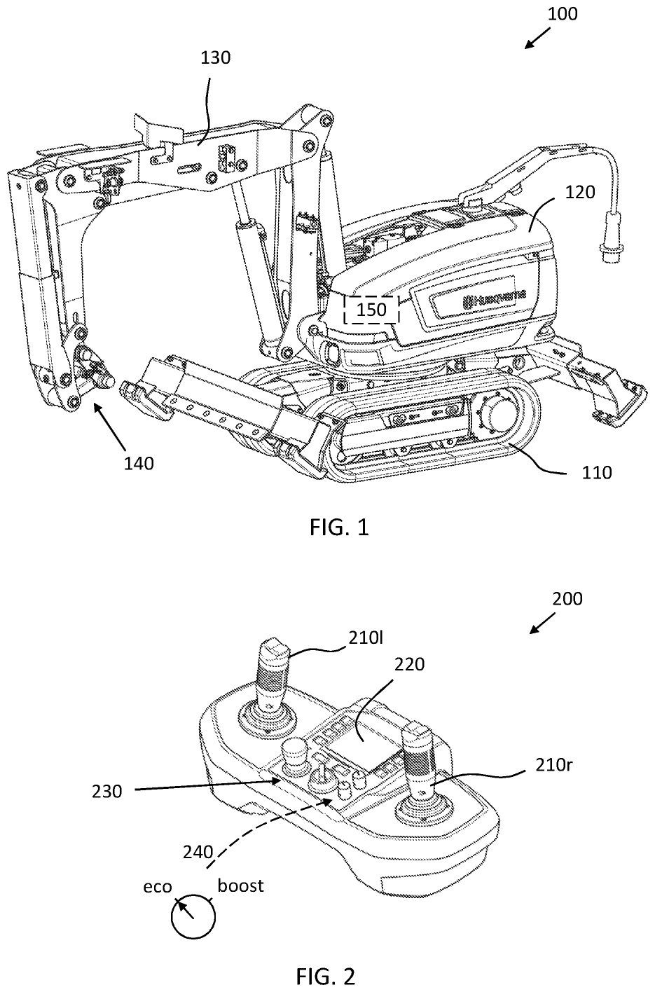

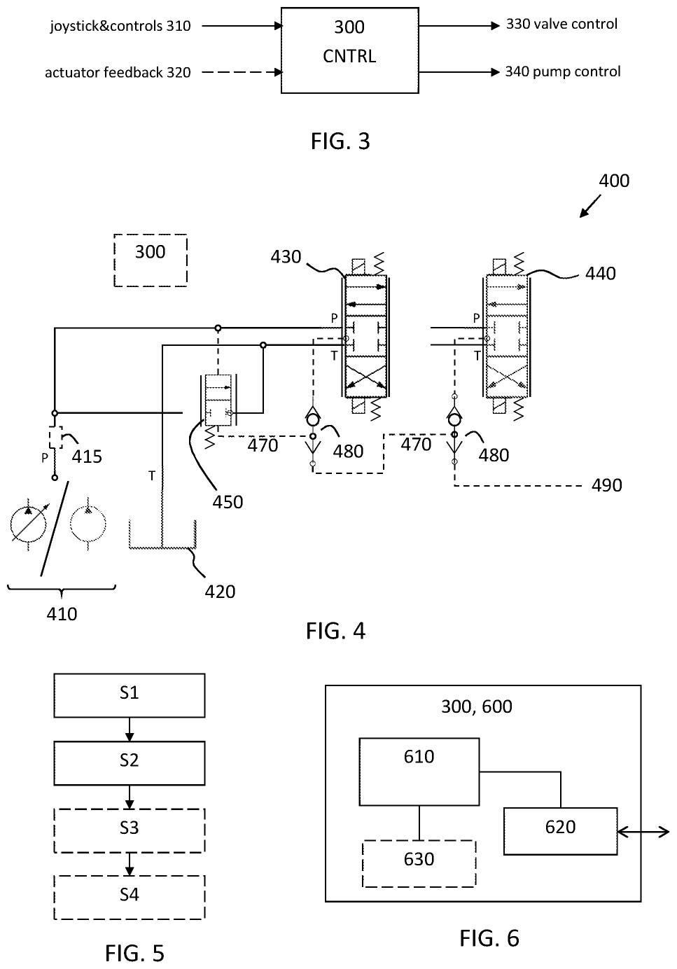

FIG. 1 illustrates a remote controlled demolition robot, which is an example of a construction machine 100. The demolition robot comprises tracks 110 for propelling the robot over ground. It is appreciated that some construction machines may be supported on wheels instead of tracks. A body 120 is rotatably mounted on the bottom section of the machine which comprises the tracks. An arm 130, sometimes referred to as tool carrier, extends from the body 120. Various work tools, such as pneumatic or hydraulic hammers and the like can be carried on the distal end 140 of the arm. The various actuators on the construction machine 100 are powered by a hydraulic system 150, which is only schematically illustrated in FIG. 1. This hydraulic system 150 is arranged to be controlled by a control device 300 which will be discussed in more detail below in connection to FIG. 3. An example 400 of the hydraulic system will be discussed in more detail below in connection to FIG. 4.

The construction machine 100 may be arranged for autonomous operation, i.e., to operate without manual instructions from an operator, or it can be remote controlled by an operator using different types of control input devices such as, e.g., levers, joysticks, touch screens or even haptic gloves and the like.

FIG. 2 illustrates an example control device 200 in the form of a wireless remote control. The control device 200 comprises left and right joysticks 210l, 210r, a display 220 for communicating information to an operator, and a plurality of buttons and levers 230 for controlling various functions on the construction machine 100. The control device optionally comprises means for selecting an operating mode of the construction machine 100, such as a first mode of operation and a second mode of operation. The first mode of operation may be associated with an improved energy efficiency while the second mode of operation may be associated with an increased performance, e.g., in terms of machine response to different commands. These two modes of operations will be discussed in detail below.

The remote control device 200 is configured to communicate with the construction machine 100 via wireless radio link, such as a Bluetooth link, a wireless local area network (WLAN) radio link, or a cellular connection link, such as the cellular access network links defined by the third generation partnership program (3GPP), i.e., 4G, 5G and so on.

FIG. 3 schematically illustrates a control unit 300 arranged to receive input commands 310 from, e.g., a joystick or the like, and optionally also actuator feedback 320 from the hydraulic system on the construction machine 100. The feedback may comprise, e.g., pressure sensor data from various places in the hydraulic system, valve states, and possibly also flow meter data.

The control unit 300 is arranged to control actuator valves 330 in order to obtain desired actions by the various parts of the construction machine 100, e.g., to move the boom 130 or trigger an action by some tool.

The control algorithms for controlling hydraulic supply pressure in many demolition robots is based on a load sensing principle. In load sensing systems, the highest load pressure is measured either by hydraulic or electrical feedback, and the supply pressure system then delivers a hydraulic pressure in excess of the load pressure by a margin (often referred to as the delta pressure) which is usually configured at around 20 bars or so (although this may differ from machine to machine). This delta pressure represents an energy loss, since the excess flow generated by the hydraulic pump is just returned to the hydraulic tank without performing any useful work. When the machine is powered up and in stand-by, but not performing any work by its actuators, the excess flow represents pure overhead.

The proposed hydraulic system comprises one or more electro proportional valves, such as one or more pressure compensated flow controlled valves, and optionally also one or more non-compensated valves, i.e., valves that are not flow compensated. A pressure compensated valve keeps the flow through the valve proportional to the valve opening by maintaining a constant pressure difference over the valve, i.e., between the pressure port and the actuator port of the valve. The valve opening, is, in turn, proportional to the input signal 310 to the control unit 300 (for a remote-controlled system) or proportional to an internally generated control signal (for an autonomous or semi-autonomous drive system). Thus, the control unit 300 is able to determine or approximate the flow through the valve or valves based on the valve states and overall hydraulic system state. The valve state comprises valve position, and the hydraulic system state may, e.g., be an operating condition of the machine, a selection of tools currently in use, and optionally also the current task performed by the machine.

The input flow to the hydraulic system provided by the hydraulic pump or pumps is, according to the present teaching, controlled in dependence of a total flow requirement of the actuators in the hydraulic system such that the hydraulic pump delivers a hydraulic flow at or just below the total flow requirement of the actuators. The total flow requirement can be obtained by first determining the flow requirement of the different actuators, and then adding the flow requirements to obtain the total flow requirement. The total flow requirement can also be tabulated in dependence of the use case. The control unit may then just determine the current use-case and then translate this information into a total flow requirement. If the pressure compensator of the pressure compensated flow controlled valve is of “normally open” type it will be fully open. This means that the pressure compensator mechanism for the actuator with highest load pressure is fully open. Thus, the hydraulic pump built up pressure corresponds to the back-pressure of the actuator with highest load pressure or in the other words there is no need for the 20 bar load sensing offset pressure. The present teaching also works with “normally closed” compensators, although perhaps at a reduced efficiency.

Practically, as will be discussed in more detail below, the control unit constantly monitors the flow requirement of each actuator, e.g., by keeping track of the valve position or positions, and controls the hydraulic pump to provide a flow equal to or slightly below the sum of the actuator flow requirements. Thus, the proposed hydraulic system is more energy efficient compared to other systems, since there is no excess flow, nor any pressure margin generated by the hydraulic pump.

In case the system comprises an actuator without a pressure compensated flow controlled valve, then this actuator will determine the working pressure of the system. Again, the output flow from the hydraulic pump will be configured at or just below the total flow requirement of the actuators on the construction machine 100, but the working pressure of the non flow-controlled valve will determine the maximum pressure in the system. A valve like this may, e.g., be arranged to control a high power actuator, such as a breaker or the like. This leads to an even more energy efficient system compared to the pressure control approach where all actuator valves are flow controlled. However, as mentioned above, the disadvantage of controlling flow after an actuator with high load power is that the operating pressure of the system will be the pressure of the high load power function. In this case other functions which need higher pressure can stop or operate with reduced functionality, which may be undesired.

If the provided flow of the pump is higher than the needed flow of functions, the excess flow is directed to tank automatically through a load sensing valve. In this case the delivered pressure is equal to the highest load pressure (load pressure signal) plus the spring setting of the load sensing valve. If higher maneuverability is needed in some cases more flow than the required can be delivered by the pump. The pressure built up caused by the excess flow can improve the reaction time of some functions. The spring setting of the load sensing valve can be between 10 to 20 bar or even higher.

The flow of compensated valve sections is proportional to the opening area of the valve. Some sections can be without pressure compensator. If the section with highest load power shall be open (power control), then that section shall not have pressure compensator.

A valve without pressure compensator can be equipped with a pressure transducer which measures load pressure. In this case the flow q (measured in liters per minute) of each valve section can be calculated numerically, as

$$q = {C}_{q} A \sqrt{\frac{2}{ρ} {Δ}_{p}}$$

where, generally C_{q}=0,67, A is the opening area of the valve, ρ is the density of the hydraulic fluid, and Δₚ is the pressure difference over the actuator valve. The value for C_{q} may optionally be configured in dependence of the particular type of valve, e.g., from a LUT, and may furthermore be set in dependence of the valve state. Such more advanced configurations of the parameter C_{q} may improve the accuracy of the flow estimation by the above formula in some cases, but in most cases a fixed and pre-determined value for this parameter, such as C_{q}=0,67, will yield acceptable accuracy.

The load sensing valve can also be equipped with a position transducer which indicates when the valve is open and optionally also the opening state of the valve, i.e., how much it is opened in relation to full opening. This can be used to assure that no excess flow is delivered to the system i.e. if more flow than needed is delivered the valve opens and sends the excess flow to tank.

FIG. 4 illustrates an example hydraulic system 400 where at least part of the concepts proposed herein are implemented. A hydraulic pump 410 provides hydraulic power to the system by providing hydraulic flow at operating pressure P. This flow is optionally measured by a flow meter 415, which is connected to the control unit 300. The flow of the hydraulic pump is controlled by the control unit 300. For instance, the hydraulic pump 410 may be a fixed displacement pump powered by a variable speed electric motor. The hydraulic pump 410 can also be a variable displacement pump. If a flow meter 415 is present, then the flow meter data can be used by the control unit 300 to obtain a more exact flow amount out from the hydraulic pump 410, however, most pumps 410 deliver a relatively accurate output flow also without a flow meter.

The actuators on the construction equipment 100 are controlled by respective actuator control valves 430, 440, where it is appreciated that the valve types shown in FIG. 4 are just example valve types. Other types of control valves are of course also possible. Any excess flow delivered by the pump 410 is returned to the hydraulic tank 420 via a load sensing system comprising a load sensing valve 450 connected to the actuator control valves 430, 440 via load sensing lines 470 and shuttle valves 480. The load sense line 470 extends also to some additional actuator control valves 490 not shown in FIG. 4. The load sensing valve 450 is normally configured with a spring setting corresponding to about 20 bars of pressure, but this setting is machine dependent. The spring setting of the load sense system may optionally be configurable by the control unit 300, e.g., in dependence of a desired system operating pressure.

To summarize, there is disclosed a hydraulic system 150, 400 for a construction machine 100. The system comprises a hydraulic pump 410, a hydraulic tank 420, one or more actuator control valves 430, 440 arranged to control respective actuators 110, 130, 140 on the construction machine 100. Of course, different types of construction machines comprise different actuators. The machine 100, e.g., comprises more actuators than explicitly indicated in FIG. 1 and a control unit 300 arranged to configure respective valve positions 330 of the actuator control valves and to control 340 a hydraulic flow generated by the pump 410. The hydraulic system is associated with at least a first mode of operation. In this mode of operation, the control unit 300 is arranged to determine a total flow requirement of the actuators and to control the hydraulic pump 410 to deliver a hydraulic flow at or below the total flow requirement of the actuators by a predetermined amount. Thus, there is no excess flow generated by the hydraulic pump, which in turn means that the energy losses in the system is reduced compared to some traditional systems where an excess flow is maintained at all times. Still, the hydraulic system is operational since the system is fed by a flow at or below the total flow requirement of the actuators by a predetermined amount. The predetermined amount of flow below the total flow requirement is configured in dependence of the hydraulic system specification and characteristics. According to an example, when in the first mode of operation, the control unit 300 is arranged to control the hydraulic pump 410 to deliver a hydraulic flow within 95% to 100% of the total flow requirement of the actuators in liters/minute.

The total flow requirement of the actuators can, for instance, be determined by the control unit 300 based on the configured valve positions 330 and overall state of the machine. The control unit can store pre-determined functions in memory which map a given valve setting to a respective valve flow, which can then be summed to obtain the total flow requirement. Such functions may, e.g., be implemented as analytical linear functions, piecewise linear function, or look-up tables (LUTs). Each valve, or a subset of the valves, 430, 440 may optionally also comprise a sensor arrangement configured to sense a differential pressure over the valve. The flow through a valve can then be determined based on the differential pressure over the valve, for instance via a LUT or pre-configured function in the control unit 300.

The hydraulic system 150, 400 may also, as mentioned above, comprise a load sensing valve 450 comprised in a load sensing system 450, 470, 480, 490. The total flow requirement of the actuators can then be determined based on a state of the load sensing valve 450, since the load sensing valve closes when a flow below the total flow requirement is delivered by the hydraulic pump 410. As long as the load sensing valve is closed, there is no excess flow in the system.

The hydraulic system 150, 400 optionally comprises a hydraulic flow meter 415 arranged to determine the hydraulic flow of the hydraulic pump 410. This hydraulic flow meter can be used by the control unit to calibrate the output flow of the hydraulic pump 410. It is noted that this flow meter is entirely optional.

The hydraulic system 150, 400 may also, as mentioned above, comprise a non flow-compensated valve arranged to control a high-power actuator. In this case the non-flow compensated valve will determine the operating pressure of the hydraulic system. For instance, if the non flow-compensated valve generates a back-pressure of 150 bars when operated, this will be the operating pressure in the system, even if some other actuator requires an operating pressure of, say, 200 bars.

It is appreciated that the hydraulic system disclosed herein may not provide the desired performance when operating in the first mode of operation. For instance, due to the lack of excess flow and/or pressure, the system may act “sluggish” during some maneuvers and operations. To mitigate this, a second mode of operation can be implemented where the hydraulic system has a higher performance, but also consumes more energy, i.e., the system is no longer as energy efficient as in the first mode of operation. In this optional second mode of operation, in some types of hydraulic systems, the control unit 300 is arranged to control the hydraulic pump 410 to deliver a hydraulic flow at a flow level above the total flow requirement of the actuators. In other systems, for the optional second mode of operation, the control unit 300 is instead arranged to control the hydraulic pump to deliver a hydraulic pressure at a pressure level above the load pressure in the system, i.e., the load sensing pressure. Further systems may comprise hydraulic pumps operating to deliver both increased flow and pressure in the optional second mode of operation.

The control unit 300 is arranged to configure the hydraulic system to operate in one of the first mode of operation and the second mode of operation. For instance, the control unit 300 can be arranged to select between the first mode of operation and the second mode of operation in dependence of which actuators that are controlled. Say for instance that the construction equipment 100 is stationary in a stand-by mode, i.e., the tracks 110 are not moving and the boom 130 is not being operated, and no tool is in operation. The control unit 300 can then configure the construction equipment in the first mode of operation, where energy efficiency is increased. The first mode of operation can also be used when no particularly energy demanding operations are being performed requiring fast response by the actuators. However, if the operator wants a more responsive machine, the second mode of operation can be selected. In this second mode of operation the actuators are likely to become more responsive due to the excess pressure generated in the hydraulic system by the hydraulic pump 410. Thus, according to some aspects, the control unit 300 is arranged to select the first or the second mode of operation in dependence of an input by an operator. This second mode of operation then becomes akin to a boost mode. The remote control device 200 may control means for enabling such a boost mode of operation. FIG. 2 illustrated one example of such means for mode selection 240, where the eco mode corresponds to the first mode of operation and the boost mode corresponds to the seconds mode of operation.

The control unit may also be configured in an automatic selection mode of operation, where the first mode of operation or the second mode of operation is selected in dependence of a set of pre-determined criteria. Such criteria may, e.g., comprise if a tool is currently in use or not, i.e., if the machine is in standby. The criteria may also comprise a tool type in case a tool in currently in use. In some cases it may be advisable to reduce machine energy consumption in dependence of an available amount of energy for operating the machine. The criteria therefore optionally comprise an estimated current energy supply of the machine, i.e., a state of charge in an energy storage such as a battery or a fuel cell stack, and/or the capacity in terms of current or power of an electrical mains connection.

According to aspects, the hydraulic pump is a variable speed drive fixed displacement pump, and the control unit is configured to maintain a variable speed drive setting above a predetermined speed value. This ensures that the pump arrangement always operates above the minimum speed value such that the hydraulic pump and/or drive motor generates enough lubrication for the different device components. This is an important feature in some systems which require a minimum drive speed at all times in order to ensure that the arrangement is properly lubricated and also that cooling works as intended to provide sufficient cooling to the hardware during use. The predetermined speed value is optionally configured in dependence of any of; a hydraulic system pressure, an operation time duration, and/or an operating temperature, which are all system parameters that determine a need for a given speed value.

FIG. 5 is a flow chart illustrating a method for controlling a hydraulic system 150, 400 of a construction machine 100, wherein the hydraulic system comprises a hydraulic pump 410 arranged to feed one or more hydraulic actuators on the construction machine 100 via respective actuator control valves 430, 440, and where at least one of the actuator control valves 430, 440 is a pressure compensated flow control valve. The method comprises determining S1 a total flow requirement of the one or more hydraulic actuators and controlling S2 the hydraulic pump 410 to deliver a hydraulic flow at a pre-determined flow level at or below the total flow requirement of the actuators in a first mode of operation. Thus, the method summarizes the above discussions.

According to aspects, the method also comprises controlling S3 the hydraulic pump 410 to deliver a hydraulic flow in excess of the total flow requirement of the actuators in a second mode of operation.

According to aspects, the method also comprises controlling S4 the hydraulic pump 410 to deliver a hydraulic pressure in excess of a load pressure of the hydraulic system

FIG. 6 schematically illustrates, in terms of a number of functional units, the general components of a control unit 600, such as the control unit 300 discussed above. This control unit can be used to implement, e.g., parts of the control device 200, 300, 600 800 or the actuator control unit 520. Processing circuitry 610 is provided using any combination of one or more of a suitable central processing unit CPU, multiprocessor, microcontroller, digital signal processor DSP, etc., capable of executing software instructions stored in a computer program product, e.g. in the form of a storage medium 630. The processing circuitry 610 may further be provided as at least one application specific integrated circuit ASIC, or field programmable gate array FPGA.

Particularly, the processing circuitry 610 is configured to cause the device 600 to perform a set of operations, or steps, such as the methods discussed in connection to FIG. 6 and the discussions above. For example, the storage medium 630 may store the set of operations, and the processing circuitry 610 may be configured to retrieve the set of operations from the storage medium 630 to cause the device to perform the set of operations. The set of operations may be provided as a set of executable instructions. Thus, the processing circuitry 610 is thereby arranged to execute methods as herein disclosed.

The storage medium 630 may also comprise persistent storage, which, for example, can be any single one or combination of magnetic memory, optical memory, solid state memory or even remotely mounted memory.

The device 130, 420 may further comprise an interface 620 for communications with at least one external device. As such the interface 620 may comprise one or more transmitters and receivers, comprising analogue and digital components and a suitable number of ports for wireline or wireless communication.

The processing circuitry 610 controls the general operation of the control unit 130, 420, e.g., by sending data and control signals to the interface 620 and the storage medium 630, by receiving data and reports from the interface 620, and by retrieving data and instructions from the storage medium 630.

1. A hydraulic system for a construction machine, the system comprising a hydraulic pump, a hydraulic tank, one or more actuator control valves arranged to control respective actuators on the construction machine, and a control unit arranged to configure respective valve positions of the one or more actuator control valves and to control a hydraulic flow generated by the hydraulic pump,
wherein at least one of the one or more actuator control valves is a pressure compensated flow control valve, and
wherein, in a first mode of operation, the control unit is arranged to determine a total flow requirement of the respective actuators and to control the hydraulic pump to deliver a hydraulic flow at or below the total flow requirement of the respective actuators by a predetermined amount.

2. The hydraulic system according to claim 1, wherein the total flow requirement of the respective actuators is determined at least in part based on the configured respective valve positions.

3. The hydraulic system according to claim 2, wherein the configured respective valve positions are determined at least in part based on a state of a control input device.

4. The hydraulic system according to claim 1, wherein each of the one or more actuator control valves comprises a sensor arrangement configured to sense a differential pressure over the one or more actuator control valves, wherein the total flow requirement of the respective actuators is determined at least in part based on the differential pressures over the one or more actuator control valves.

5. The hydraulic system according to claim 1, further comprising a load sensing valve comprised in a load sensing system, wherein the total flow requirement of the respective actuators is determined based on a state of the load sensing valve, wherein the state comprises a valve opening.

6. The hydraulic system according to claim 1, wherein at least one of the one or more actuator control valves is an electro proportional flow compensated valve.

7. The hydraulic system according to claim 1, also comprising a non flow-compensated valve arranged to control a high-power actuator.

8. The hydraulic system according to claim 1, wherein, in a second mode of operation, the control unit is arranged to control the hydraulic pump to deliver a hydraulic flow at a flow level above the total flow requirement of the respective actuators, wherein the control unit is arranged to configure the hydraulic system to operate in one of the first mode of operation and the second mode of operation.

9. The hydraulic system according to claim 1, wherein, in the second mode of operation, the control unit is arranged to control the hydraulic pump to deliver a hydraulic pressure above a load pressure in the hydraulic system, wherein the control unit is arranged to configure the hydraulic system to operate in one of the first mode of operation and the second mode of operation.

10. The hydraulic system according to claim 8, wherein in an automatic selection mode of operation, the control unit is arranged to select between the first and the second mode of operation in dependence of a pre-determined set of selection criteria.

11. The hydraulic system according to claim 8, wherein the control unit is arranged to select the first or the second mode of operation in dependence of which of the respective actuators that are controlled.

12. The hydraulic system according to claim 8, wherein the control unit is arranged select the first or the second mode of operation in dependence of an input by an operator.

13. The hydraulic system according to claim 1, comprising a hydraulic flow meter arranged to determine the hydraulic flow of the hydraulic pump.

14. The hydraulic system according to claim 1, wherein, in the first mode of operation, the control unit is arranged to control the hydraulic pump to deliver a hydraulic flow within 95% to 100% of the total flow requirement of respective actuators in liters/minute.

15. The hydraulic system according to claim 1, comprising a load sensing system with at least one load sensing valve, wherein the hydraulic pump is a variable speed drive fixed displacement pump, and wherein control unit is configured to maintain a variable speed drive setting above a predetermined speed value.

16. The hydraulic system according to claim 13, wherein the predetermined speed value is configured in dependence of any of; a hydraulic system pressure, an operation time duration, and/or an operating temperature.

17. A construction machine comprising the hydraulic system according to claim 1, wherein the hydraulic system is at least partly powered by an electric storage device.

18. (canceled)

19. A method for controlling a hydraulic system of a construction machine, wherein the hydraulic system comprises a hydraulic pump arranged to feed one or more hydraulic actuators on the construction machine via respective actuator control valves, and wherein at least one of the actuator control valves is a pressure compensated flow control valve, the method comprising
determining a total flow requirement of the one or more hydraulic actuators, and
controlling the hydraulic pump to deliver a hydraulic flow at a pre-determined flow level at or below the total flow requirement of the actuators in a first mode of operation.

20. The method according to claim 19, further comprising controlling the hydraulic pump to deliver a hydraulic flow in excess of the total flow requirement of the actuators in a second mode of operation, and
controlling the hydraulic pump to deliver a hydraulic pressure in excess of a load pressure of the hydraulic system.

21. (canceled)

22. (canceled)

23. A hydraulic system for a construction machine, the system comprising a hydraulic pump, a hydraulic tank, one or more actuator control valves arranged to control respective actuators on the construction machine, and a control unit arranged to configure respective valve positions of the one or more actuator control valves and to control a hydraulic flow generated by the hydraulic pump,
wherein the hydraulic pump is a variable speed drive fixed displacement pump,
wherein the hydraulic system comprises a load sensing valve arranged to regulate a hydraulic pressure in the hydraulic system to be below a pre-determined offset over the maximum load pressure.
